(19) United States
(12) Patent Application Publication
(10) Pub. No.: US 2009/0187770 A1
(43) Pub. Date: Jul. 23, 2009

(54) Data Security Including Real-Time Key Generation

(75) Inventors: Xiaobing Cao, Shanghai (CN); Qi Li, Shanghai (CN); Yi Feng, Shanghai (CN); Qingheng Wang, Shanghai (CN)

Correspondence Address: MOSYS Incorporated;Patent Counsel, 755 North Mathilda Ave., Sunnyvale, CA, 94085, US

(73) Assignee: ATMEL CORPORATION, San Jose, CA (US)

(21) Appl. No.: 11/571,242

(22) PCT Filed: Feb. 9, 2006
(86) PCT No.: PCT/US06/04800

§ 371 Date: Aug. 23, 2007

(51) Int. Cl. H04L 9/06

(52) U.S. Cl. 713/193; 380/277

(57) ABSTRACT

Methods for providing data security are described. A security device (10) and a plug-in device (30) work in conjunction to enable encryption and decryption of data. A secret is stored by one of the security device (10) or the plug-in device (30). While the secret is required for constructing a key, the key cannot be constructed from the secret alone. Unauthorized devices or users are thereby prevented from accessing the key.

### BACKGROUND

This invention relates to data security.

In today's digital world, information is more readily accessible than ever. Businesses are increasingly dependent on digital communications. However, the promulgation and ease of use of digital communication technologies has come at some price: increased exposure to security threats. Conventional digital communication technologies allow for easy storage, retrieval and transfer of information. What is needed are equally easy means for securing valuable information.

Referring to FIG. 1, a conventional host computer 20 is in communication with a mass storage device 40 for storing data. Often, a user of the host computer 20 wishes to keep data stored on the mass storage device 40 secure, so that only authorized users can access the data. The user can select from a number of conventional ways to protect the data. For example, the user can password protect access to the data. However, if the hard disk is removed from the mass storage device 40 and installed into an unprotected computer, password protection may be lost and the data may be exposed. Another conventional way of protecting the data is through the use of software or hardware (or a combination of both) encryption technologies. Some of the disadvantages associated with software encryption include memory resource requirements and non-real time processing. Some hardware encryption technologies require storing a key in a hardware device, such as on storage media, for example, on a hard disk, floppy disk, EEPROM, flash or optical recordable disk. However, known hardware encryption technologies do not protect the key when the key is stored or loaded to and from the hardware device. Hardware devices can also be susceptible to spy programs. More robust ways of protecting critical data are therefore desirable.

### SUMMARY

In some implementations, methods of providing data security in a security device are provided. The method includes coupling a plug-in device to a security device, the security device controlling an encryption or decryption of data to or from an associated storage device. When a data encryption or decryption operation is required, a secret is retrieved from a plug-in device. A host seed is recovered from the secret. A key is generated from the host seed to be used in the encryption or decryption of data.

In some implementations, methods of providing data security include receiving a request to facilitate secure encryption or decryption operations; providing a randomly generated number; receiving a secret created from the randomly generated number and a host seed; and storing the secret until run-time.

In some implementations, a plug-in device for providing data security includes a random number generator to generate a random number; an encryption engine to encrypt the random number; a matching engine to compare the encrypted random number to a received encrypted random number; and a memory for storing a secret to be shared with a security device if the matching engine determines a match has been made.

In some implementations, a security device includes a means for connecting to a host computer for receiving a host seed; a memory configured to store at least one of a device seed or a random number; and a processor configured to hide the host key in a secret, extract the host seed from the secret and create a key from the host seed, but only when coupled to an authenticated device that stores the secret.

In some implementations, a system for securing data includes a host computer, a security device, an authenticatable device and data storage. The security device includes a means for connecting to the host computer for receiving a host seed, a memory for storing at least one of a device seed or a random number and a processor configured to hide the host key in a secret, extract the host seed from the secret and create a key from the host seed but only when coupled to an authenticatable device that stores the secret. The authenticatable device is configured to generate the random number and to store the secret. The data storage stores encrypted data.

The methods and devices described herein may provide none, one or more of the following advantages. Together, a plug-in device in combination with a data security device can provide a robust data security method. Secret information, such as a mixed seed, can be stored on the plug-in device. The mixed seed and/or the plug-in device may be required to create a key for encryption or decryption of critical data. However, possession of the plug-in device alone is insufficient for creating the key. Information stored on the security device is also required to construct the encryption/decryption key. Because both the plug-in device and the security device are required to create the key, possession of the security device alone is also insufficient for creating the encryption/decryption key. If either the plug-in device or the security device are compromised, the key is not compromised.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic of a host computer in communication with a storage device.

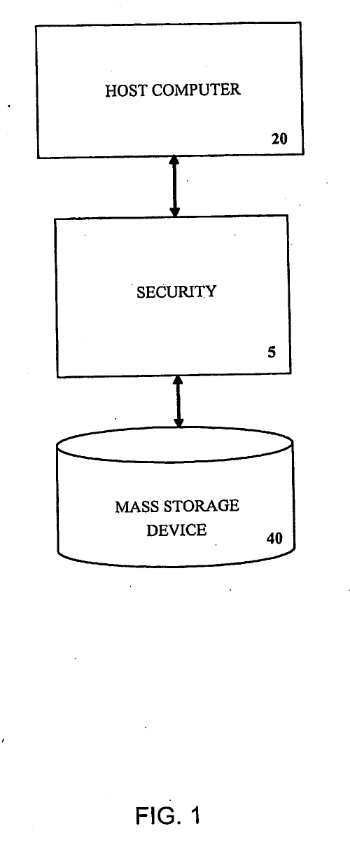

FIG. 2 includes a schematic of a security device configured to communicate with a plug-in device.

FIG. 3 is a flow diagram for preparing and using a plug-in device for security.

FIG. 4 is a flow diagram describing publishing a secret to the plug-in device.

FIG. 5 is a flow diagram for authorizing and verifying the plug-in device and the security device.

FIG. 6 is a flow diagram for loading the secret from the plug-in device to generate a key.

Like reference symbols in the various drawings indicate like elements.

### DETAILED DESCRIPTION

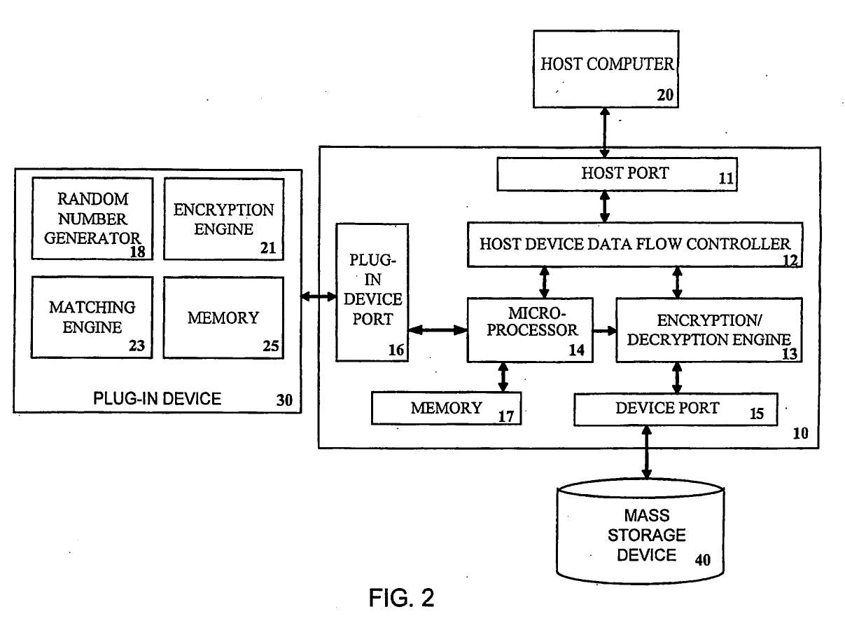

Referring to FIG. 2, a data security device and plug-in device together can protect data stored on a storage device. A data security device 10 is connected to a host device (e.g., host computer 20), a plug-in device 30 and a storage device (e.g., mass storage device 40) by various communication mediums. The communication mediums form signal paths between the respective devices and can be of the form of electrical, optical, radio frequency or other communication media.

The host device can be of the form, and is shown, as a computer. The storage device can be of the form, and is shown, as a mass storage device. While reference is made to a host computer 20 and a mass storage device 40, this reference is merely exemplary. The security device 10 and plug-in device 30 can be associated with other host devices (e.g., personal computer, laptop computer, personal digital assistant, access point, portable electronic device, game console, set-top box, or other information processing device) and other storage devices (e.g., hard drive, optical drive, flash drive, etc.). Similarly, while reference is made to individual components one or more of the host device, plug-in device, security device, and storage device can be integrated. For example, in one implementation, a security device 10 can be integrated with mass storage device 40 in a disk key device (e.g., a flash or disk USB drive) that is configured to be coupled to one or more host devices.

### Data Security Device

Data security device 10 operates to work with the host device and the plug-in device to create one or more keys for use in encrypting and decrypting data to be stored on (and/or retrieved from) the storage device. Accordingly, data security device 10 includes three primary interfaces: a host interface (e.g., host port 11 for communicating with the host computer 20), a plug-in device interface (e.g., plug-in device port 16), and a storage device interface (e.g., device port 15 for communicating with the mass storage device 40). In the particular implementation shown the data security device 10 includes a plug-in device port 16 for directly accessing a plug-in device 30. Other communication configurations between the data security device 10 and the plug-in device, host device and storage device are possible. As will be discussed in greater detail below, the plug-in device 30 stores and retrieves secret information that is required for creating a key used to encrypt and decrypt data stored in the mass storage device 40. In one implementation, the data security device 10 also includes a host-device data flow controller 12, which directs data going to or coming from the host computer 20, an encryption/decryption engine 13, for encrypting data going to the mass storage device 40 or decrypting data coming from the mass storage device 40, a microprocessor 14 and memory 17.

The host port 11 is in communication with host computer 20 and the host-device data flow controller 12. The host port 11 receives commands and data from the host computer 20 and communicates the commands and data to the host-device data flow controller 12 for processing. The host port 11 also communicates the status of executed commands and returned data from the mass storage device 40 to the host computer 20. In one implementation, the host computer 20 and the security device 10 are connected with a host side bus of any suitable type, such as PCI, PCI express, USB, 1394, ATA, serial ATA, SCSI, or FiberChannel.

The host-device data flow controller 12 is in communication with the host port 11, the encryption/decryption engine 13 and the microprocessor 14. The host-device data flow controller 12 receives commands and data from the host port 11 and processes the commands and data in two categories. A first category includes commands for accessing the mass storage device 40. A second category includes key management commands. Other categories of commands are possible. The host device data flow controller 12 communicates commands for accessing the mass storage device 40 and associated data to the encryption/decryption engine 13. The host-device data flow controller 12 communicates key management commands and associated data to the microprocessor 14. The host-device data flow controller 12 also receives returned status information and data from the encryption/decryption engine 13 and the microprocessor 14 and provides these as required to the host computer using the host port 11.

The encryption/decryption engine 13 is in communication with the host-device data flow controller 12 and the microprocessor 14. The encryption/decryption engine 13 encrypts data traveling from host computer 20 to mass storage device 40 and decrypts data traveling from mass storage device 40 to host computer 20. In one implementation, the encryption/decryption engine 13 does not process commands and associated returned status information (i.e., can pass the information through as required unchanged). As will be discussed in greater detail below, the microprocessor 14 creates the key used by the encryption/decryption engine 13 to encrypt/decrypt data. The encryption/decryption engine 13 can use an encryption/decryption algorithm selected from published and verified algorithms, such as AES and DES, or other suitable algorithms.

The microprocessor 14 is in communication with the host-device data flow controller 12, the encryption/decryption engine 13, the plug-in device port 16 and the memory 17. Though reference is made to a microprocessor, other processing devices are possible including microcontrollers, or other controllers. In one implementation, the microprocessor 14 controls various operational processes of the data security device 10, including sending a response to requests from the host computer 20 (e.g., to store or retrieve data or process a host seed) and storing and loading data to and from the plug-in device 30. The microprocessor 14 also controls the generation of a key for encryption and decryption.

The microprocessor 14 can retrieve instructions from the memory 17 or store data in the memory 17. Memory 17 can include volatile and/or non-volatile memory including random access memory, read only memory (including EPROMs and the like), flash memory, etc.

The device port 15 is in communication with the encryption/decryption engine 13 and mass storage device 40. The device port 15 receives reported command status and data from mass storage device 40 and communicates the command status and data to the encryption/decryption engine 13. In the reverse direction, the device port 15 also receives commands and data from the encryption/decryption engine 13 and communicates the commands and data to the mass storage device 40. The device side bus connecting the security device 10 to the mass storage device 40 can be the same type as the host side bus or of a different type. Either bus can also be defined as a vendor specific bus.

The plug-in device port 16 communicates with a plug-in device 30 and the microprocessor 14. Though reference is made to a plug-in port, other means of communicating with the plug-in device are possible. As will be discussed in detail below, plug-in device 30 may be otherwise coupled to the security device (i.e., not by a plug-in connection). Accordingly, the description provided here is merely exemplary. The plug-in device port 16 can be controlled by the microprocessor 14 allowing for access to the plug-in device 30, such as writing to and reading from the plug-in device 30. In some implementations, the data security device 10 has an interface configured to conform to a specific plug-in device standard, such as ISO-7816. In one implementation, the plug-in device port 16 provides a secure channel for transmitting information between the security device 10 and the plug-in device 30. In some implementations, data is transferred securely to and from the plug-in device 30 using a specified plug-in device data transfer protocol. The data moving between the plug-in device 30 and the security device 10 can also be encrypted, such as by DES, AES or 3DES. The plug-in device 30 can be physically located in very close proximity to the security device 10. In some implementations, the plug-in device 30 plugs into a receptacle in the security device 10.

### Plug-In Device

By way of example, reference is made to a plug-in device as being a device that interfaces with the security device 10 and stores a secret which is required to enable the encryption and/or decryption of data stored on the mass storage device. Those of ordinary skill in the art will recognize that the device can be coupled by other means to the security device 10. Characteristics of the plug-in device include its ability to be removed from the security device (e.g., communicatively and/or physically disconnected), authentication capabilities and ability to store a secret. One example of a plug-in device that can be used is a smart card. Other types of devices are possible including a USB device, a chip card, EEPROM, flash, or an IC (integrated circuit) card. In one implementation, the plug-in device 30 includes a random number generator 18, an encryption engine 21, a matching engine 23 and a memory 25.

Random number generator 18 can be used to generate a random or pseudo random number for use in an authentication protocol between the plug-in device 30 and the security device 10. Authentication protocols are discussed in greater detail below.

Encryption engine 21 can be used to encrypt a random number generated by the random number generator 18 using a key that is provided at the time the plug-in device is created (e.g., an authentication key). Details of the use of the encryption engine are discussed below.

The matching engine 23 can be used as part of the authentication protocol and determine whether a number or a string of data received by the plug-in device 30 from security device 10 matches a number or string of data generated or stored by the plug-in device 30 (e.g., matches data produced by encryption engine 21). Matching engine 23 processes and authentication protocols are discussed in greater detail below.

A system including the components described above is used to store and access encrypted data. Secure encryption and decryption methods are described further herein.

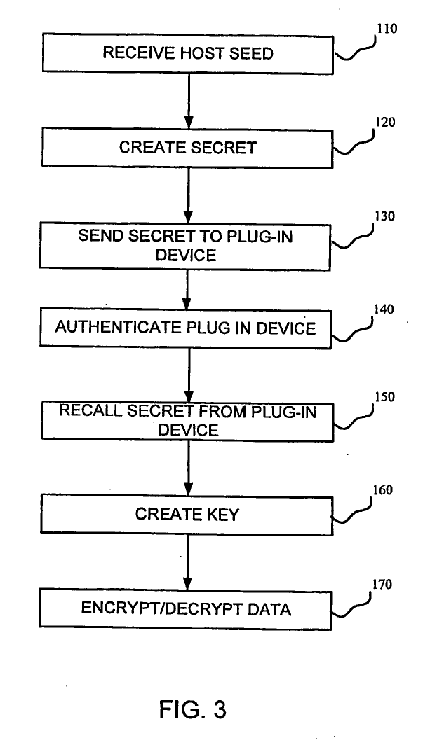

Referring to FIG. 3, a method is shown for securely encrypting or decrypting data. The method can be executed in a processing device that is in communication with various other components of a secure communication system. The process begins with the receipt of a host seed (e.g., by the data security device 10 from the host computer 20) (step 110). A secret is created from the host seed (e.g., the security device 10 can create a mixed seed from the host seed and a random number) (step 120). As used herein, a mixed seed refers to a data structure that is constructed from the host seed that can be used to hide the host seed in the event of compromise. One method for creating the mixed seed includes mixing the host seed with a mixing element (e.g., a random or pseudo random number). The mixed seed can be stored securely and the host seed recovered when required using a inverse operation (e.g. using the mixing element). The details of creating a mixed seed are discussed in greater detail below. The secret (e.g., mixed seed) is then provided and stored in a separate secure device (e.g., the mix seed is provided to the plug-in device 30 for storage) (step 130).

The separate secure device can be decoupled as desired. When coupled (e.g., when the plug-in device 30 is coupled to the security device 10) an authentication process can be performed (e.g., the security device 10 authenticates the plug-in device 30) (step 140). Authentication protocols are discussed in greater detail below. At run time (e.g., when encryption or decryption of data is required), the secret (e.g., mixed seed) can be retrieved (e.g., the security device 10 recalls the mixed seed from the plug-in device 30) (step 150). The secret is used to create a encryption/decryption (E/D) key (step 160). The creation of the E/D key can include the recovery of the host seed from the secret and the mixing or otherwise of the host seed with a device seed to create the E/D key. Creation of the E/D key will be discussed in greater detail below. Thereafter, the E/D key can be used (e.g., by the security engine 10) to encrypt and decrypt data (e.g., moving between the host computer 20 and the mass storage device 40) (step 170). The process described allows a security device to create the E/D key on-the-fly and only after authenticating of the plug-in device. In one implementation, the E/D key that is used for encryption and decryption is maintained only as long as required for a specific encryption or decryption operation. Alternatively, the E/D key can be maintained as long as the plug-in card 30 is connected to the security device 10. Once the plug-in device 30 is disconnected from the security device 10, the E/D key is either erased from memory, or the encryption/decryption engine 12 is disabled. Many of the foregoing steps are described further herein. The foregoing steps will be described with reference to the communication system shown in FIG. 2, though those of ordinary skill in the art will recognize that the methods describe can be performed by other individual or integrated systems.

### Creating a Secret

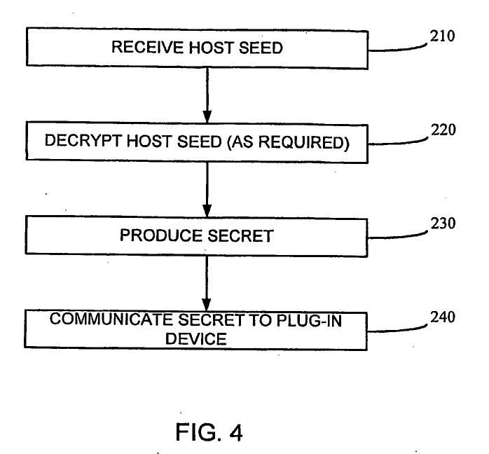

Referring to FIG. 4, a method is shown for processing a host seed received from a host device and the creation of a secret to be stored in a separate device. The process includes the security device 10 publishing the secret (e.g., the mixed seed) to the plug-in device 30 for the plug-in device 30 to store. The security device 10 may detect that a plug-in device 30 is connected to the plug-in device port 16 or may receive a request from the host computer 20 to start the publication process. In either event, the security device 10 receives a host seed from the host device (e.g., host computer 20) (step 210). In one implementation, the host computer 20 encrypts the host seed and sends the encrypted host seed to the security device 10. Alternatively, the host seed may not be encrypted and may be transmitted over a secure communication link without separate encryption. If the host seed is encrypted, the security device 10 (e.g., microprocessor 14) decrypts the encrypted host seed to recover the host seed (step 220). Thereafter, a secret is created (step 230).

In one implementation the secret is a mixture of a data generated by the plug-in card 30 (e.g., a random or pseudo random number generated by the plug-in card 30) and the host seed. In some implementations, the microprocessor 14 sends a request to the plug-in device 30 to generate a random number. The plug-in device's random number generator 18 generates the random number and the plug-in device 30 sends the number to the microprocessor 14. In other implementations, the security device generates the random number or retrieves the random number from memory 17. The random number can be random or pseudo random. The microprocessor 14 then scrambles the host seed with the random number to produce the secret (referred to herein as the mixed seed).

Thereafter, the secret (e.g., mixed seed) can be communicated to the plug-in device 30 for storage (e.g., the microprocessor 14 can send the mixed seed to the plug-in device's memory 25) (step 240). In some implementations, only one mixed seed can be stored on a plug-in device 30.

In some implementations, the system can allow the publication of the secret to a new plug-in device 30 if the original plug-in device 30 is corrupted or lost. For example, if a new plug-in device 30 is required to store the secret, the security device 10 can recall the random number from its own memory, request the host seed from the host device and re-create the secret (e.g., mixed seed). The security device 10 can then publish the mixed seed to the new plug-in device 30.

### Communicating with the Plug-In Device

As described above, the security device 10 can communicate with the plug-in device 30 including transferring the secret. The communications can include an authentication routine as will be discussed below. The authentication can be performed each time the plug-in device 30 is coupled to the security device 10. Reference is made to one protocol for authenticating the security device 10 and the plug-in device 30. The one protocol is exemplary, and other protocols can be used. Reference as well will be made to an authentication key that can be used in the authentication protocol. The authentication key can be made known to both the plug-in device 30 and security device 10 by various means, including at a time of manufacture or otherwise. The authentication key is stored by both the security device 10 and plug-in device 30 to be used during an authentication process. In some implementations, the authentication key is assigned by the host computer 20. Optionally, for additional security, a PIN can also be assigned to the plug-in device 30 and the security device 10. The PIN can be a number that is not known to the host computer 20, but only known to the security device 10 and the plug-in device 30.

In some implementations, the security device 10 authenticates the plug-in device 30 prior to publishing the secret (e.g., the mixed seed) to the plug-in device 30. The authentication process can be used each time a plug-in device 30 is connected to the security device 10 and the security device 10 is used to encrypt or decrypt data. When a user couples the plug-in device 30 to the port (e.g., plug-in device port 16) of the security device 10, the security device 10 detects the plug-in device 30. The plug-in device 30 and the security device 10 can then take part in a one or two-way challenge to ensure data security. In some implementations, a request from the host computer 20 begins the authentication process.

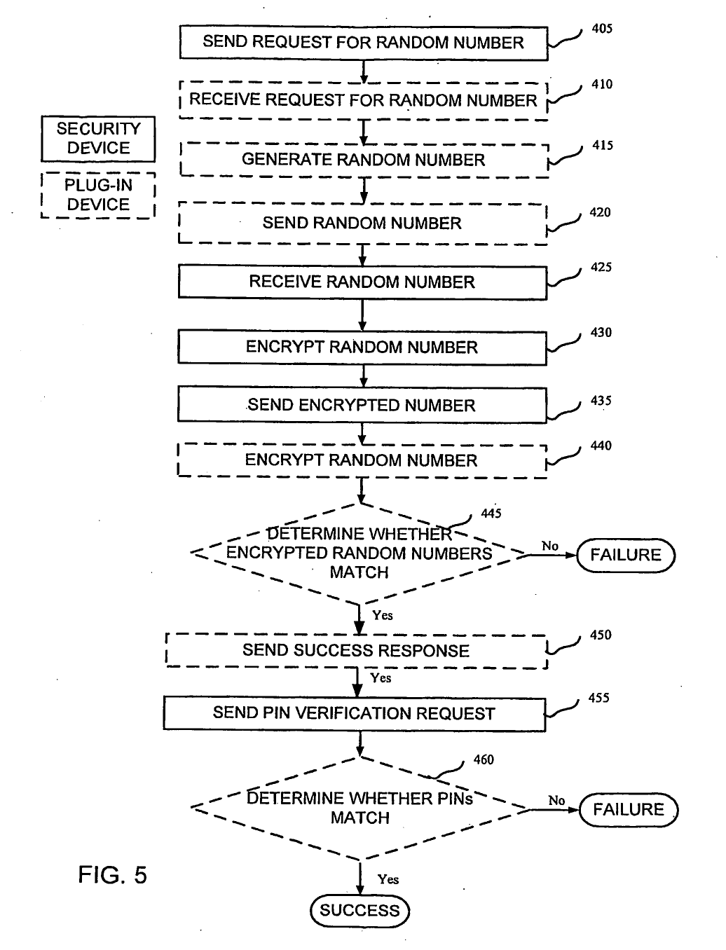

Referring to FIG. 5, one implementation for a combined authentication and secret sharing method are shown where the security device 10 (whose steps are shown in solid line) and the plug-in device 30 (whose steps are shown in dashed line) each perform steps in the authentication and sharing method. The process begins with the security device 10 sending a request to the plug-in device 30 for a random number (step 405). The plug-in device 30 receives the request (step 410) and generates a random number (step 415). The random number can be the same number as the number used to create the secret (e.g., mixed seed) or a different number (e.g., as part of an authentication process, the plug-in device may generate a random number which is used to authenticate that the plug-in device and the security device both have the correct authentication key and PIN as discussed in further detail below (this process may it self be separate from the secret sharing process described above)). The plug-in device 30 sends a response including the random number to the device 10 (step 420). The transmission of the random number can be on a secure communication link or otherwise be secured.

The device 10 receives the random number (step 425) and encrypts the received random number (step 430). The security device 10 uses an authentication key that is known to both the security device 10 and the plug-in device 30 to encrypt the random number. In one implementation, the authentication key is written to the plug-in device 30 during publication. The security device 10 can use a standard, such as DES, 3DES, or AES for encrypting the random number. Other suitable keys or algorithms may also be used, as long as both are known to the plug-in device 30 and the security device 10.

The security device 10 sends an external authentication request with the encrypted random number back to the plug-in device 30 (step 435). In parallel or in response to the received communication from the security device 10, the plug-in device's encryption engine 21 also encrypts the random number using its authentication key and encryption algorithm (assuming these to be the same as those used in the security device 10) (step 440). Thereafter, the plug-in device 30 checks whether the plug-in device's encrypted random number matches the security device's encrypted random number (step 445). If the two encrypted numbers do not match, the plug-in device 30 sends a failure response to the security device 10 and the challenge ends. If the two encrypted numbers match, the plug-in device can send a success response (step 450). This completes the authentication process.

Optionally, the security device 10 performs a further validation of the plug-in device 30 after authentication. The validation step can ensure that the plug-in device 30 is bonded to the security device 10. In the validation portion, the security device 10 sends a personal identification number (i.e., PIN) verification request with a PIN to the plug-in device 30 (step 455). The plug-in device 30 checks whether its stored PIN is equal to the received PIN (step 455). If the PINs do not match, the plug-in device 30 sends a failure response and the challenge ends. If the PINs match, the plug-in device 30 sends a success response and the challenge ends successfully. The PIN verification can be used to tie a particular plug-in device 30 to a particular security device 10. In one implementation, the PIN is created when the plug-in device is initialized by host request.

While reference is made to a particular authentication protocol above, other authentication schemes are possible, including ones that verify one or both of the communicating parties. Further, while reference is made to particular actions being performed by either the plug-in device 30 or the security device 10, those actions can be performed by the other in alternative implementations using alternative authentication protocols.

### Encryption/Decryption Process

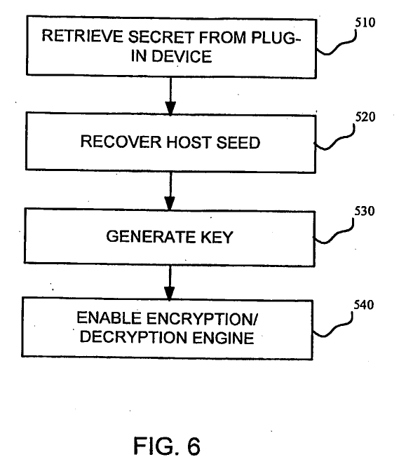

Once the plug-in device 30 and security device 10 have successfully completed the authentication (including PIN validation as required), security device 10 can create a key (the E/D key) and initiate the encryption/decryption process, as shown in FIG. 6. In one implementation, the security device must authenticate a plug-in device 30 prior to creating the E/D key. The security device 10 retrieves (or receives) the secret (e.g., mixed seed) from-plug-in device 30 (step 510). The host seed then is recovered from the secret (step 520). Where a mixed seed is used, the security device 10 (e.g., the microprocessor 14 of the security device 10) can restore the host seed from the mixed seed by descrambling the mixed seed with the previously received random number. In some implementations, the security device 10 stores the random number for retrieval to extract the host seed as required. Thereafter the E/D key is created (step 530). In one implementation, the microprocessor 14 combines the host seed with a device seed to generate the E/D key. In one implementation, the device seed is created when the security device 10 is initialized. In one implementation, each security device has a unique device seed. The device seed can be stored in memory 17 for subsequent retrieval. Finally, the encryption/decryption engine 12 can be enabled that is, the engine can begin encrypting or decrypting once in possession of the E/D key (step 540).

In some implementations, the security device 10 is able to detect when the plug-in device 30 is removed or disconnected. The security device 10 can shut down the encryption/decryption engine 13 and prevent the host computer 20 from storing or accessing any further data to or from the mass storage device 40. In some implementations, when the security device 10 detects that the plug-in device 30 has been removed, the security device wipes the E/D key from memory.

Although the system has been described as having one host, multiple hosts can be in communication with the security device 10. The security device 10 can allow each of the hosts to access or store data securely, as long as the plug-in device 30 is in communication with the security device 10.

In some implementations, the configuration of the system is modified from the system shown in FIG. 2. The host computer 20 can connect to the plug-in device 30, the mass storage device 40 and the security device 10. The host computer 20 can pass the data to be encrypted or decrypted to and from the security device 10 and the mass storage device 40, as required.

Methods are described for performing encryption and decryption of data with a highly secure key management technology. The methods described herein create a key that is only in existence at run time. The key is not stored in memory and is not transferred to or from a security device. Thus, the key cannot be retrieved from memory when the plug-in device and the security device are not in use together, such as when the plug-in device or the security device are individually stolen. This prevents the key from being accessed by someone who does not have both the proper security device and the proper plug-in device.

In one implementation, the plug-in device does not store the E/D key, but rather stores a mixed seed, that is, a hybrid of a host seed and a random number. The host seed is first extracted from the mixed seed before being combined with a device seed to create the E/D key. Gaining control of only the device only provides access to the device seed, which is insufficient for creating the E/D key. Gaining control of the plug-in device only provides the mixed seed, which is also insufficient for re-constructing the E/D key. Thus, both the correct plug-in device and the correct security device are needed together to produce the desired E/D key. If the plug-in device, the data connection between the mass storage device and the security device, or security device are compromised individually, the data is still safe.

The mass storage device 40 need not be located physically close to the security device 10. Because any information that is transmitted between the mass storage device 40 and the security device 10 is encrypted, access by an outsider, that is, someone other than a user of the host computer 20, only permits access to encrypted data.

A number of embodiments of the invention have been described. Nevertheless, it will be understood that various modifications may be made without departing from the spirit and scope of the invention. For example, the plug-in device can be replaced by a different readable medium that includes an integrated circuit or is in a compact size that is easy for a user to transport and carry. Alternative or additional verification steps can be initiated before the mixed seed is transferred from the plug-in device to the security device. Any random numbers or PINs described herein can be exchanged for passwords or strings of text including both symbols, letters, numbers or a combination thereof. Accordingly, other embodiments are within the scope of the following claims.

What is claimed is:

1. A method of providing data security in a security device, comprising:
coupling a plug-in device to a security device, the security device controlling an encryption or decryption of data to or from an associated storage device;
when a data encryption or decryption operation is required, retrieving a secret from a plug-in device;
recovering a host seed from the secret; and
generating a key from the host seed to be used in the encryption or decryption of data.

2. The method of claim 1, further comprising encrypting or decrypting data with the key.

3. The method of claim 1, where recovering a host seed from the secret comprises descrambling a mixed seed with a random number.

4. The method of claim 3, further comprising receiving the random number from the plug-in device.

5. The method of claim 1, where generating a key from the host seed comprises generating the key from the host seed and a device seed.

6. The method of claim 1, where the method further comprises authenticating the security device prior to retrieval of the secret.

7. The method of claim 6, where authenticating comprises encrypting a random number to create an encrypted random number, sending the encrypted random number to the plug-in device and receiving a success message from the plug-in device.

8. The method of claim 6, where successfully authenticating the plug-in device is required to perform the step of creating a key from the host seed.

9. The method of claim 1, further comprising:
detecting that the plug-in device has been disconnected from a security device; and
in response to detecting the disconnection, removing the key from memory or disabling any encrypting or decrypting functions.

10. A method of providing data security, comprising:
receiving a request to facilitate secure encryption or decryption operations;
providing a randomly generated number;
receiving a secret created from the randomly generated number and a host seed; and
storing the secret until run-time.

11. The method of claim 10, further comprising:
authenticating a requestor of the mixed seed; and
providing the mixed seed to the requestor after successfully authenticating the requester.

12. The method of claim 11, where authenticating the requestor comprises:
encrypting a randomly generated number to create a locally encrypted randomly generated number;
comparing the locally encrypted randomly generated number with an encrypted randomly generated number received from the requestor; and
determining if there is a match, and if so, providing the secret to the requester.

13. The method of claim 11, further comprising performing a validation step, including determining whether a sequence of data received from the requester matches a stored sequence of data.

14. The method of claim 11, wherein the randomly generated number provided in the providing step is the randomly generated number encrypted to create a locally encrypted randomly generated number.

15. A plug-in device for providing data security, comprising:
a random number generator to generate a random number;
an encryption engine to encrypt the random number;
a matching engine to compare the encrypted random number to a received encrypted random number; and
a memory for storing a secret to be shared with a security device if the matching engine determines a match has been made.

16. The plug-in device of claim 15, where the matching engine is configured to determine whether a number encrypted by the encryption engine matches a received encrypted number.

17. The plug-in device of claim 15, where the memory is configured to store a mixed seed that has been combined with a random number generated by the random number generator.

18. The plug-in device of claim 15, wherein:
the memory is configured to store an authentication key used by the encryption engine to encrypt a random number generated by the random number generator; and
the matching engine determines whether the random number encrypted with the encryption key matches a received encrypted random number.

19. The plug-in device of claim 15, where the plug-in device is a smart card.

20. A security device, comprising:
a means for connecting to a host computer for receiving a host seed;
a memory configured to store at least one of a device seed or a random number; and
a processor configured to hide the host key in a secret, extract the host seed from the secret and create a key from the host seed but only when coupled to an authenticated device that stores the secret.

21. The security device of claim 20, further comprising a means for connecting to a plug-in device to enable communication of the secret between the security device and the authenticated device.

22. The security device of claim 20, further comprising a means for connecting to a data storage device, the data storage device storing data encrypted using the key.

23. A system for securing data, comprising:
a host computer;
a security device comprising:
a means for connecting to the host computer for receiving a host seed;
a memory for storing at least one of a device seed or a random number; and
a processor configured to hide the host key in a secret, extract the host seed from the secret and create a key from the host seed but only when coupled to an authenticatable device that stores the secret;
an authenticatable device configured to generate the random number and to store the secret; and
data storage for storing encrypted data.

24. The system of claim 23, where the security device further comprises means for connecting to the data storage.

25. The system of claim 23, where the processor creates the key from the host seed and the device seed.

26. A computer-readable medium including instructions, which when executed by a processor, causes the processor to perform the operations of:
coupling a plug-in device to a security device, the security device controlling an encryption or decryption of data to or from an associated storage device;
when a data encryption or decryption operation is required, retrieving a secret from a plug-in device;
recovering a host seed from the secret; and
generating a key from the host seed to be used in the encryption or decryption of data.

27. The computer-readable medium of claim 26, further comprising instructions to cause the processor to perform the operations of encrypting or decrypting data with the key.

28. The computer-readable medium of claim 26, where recovering a host seed from the secret comprises descrambling a mixed seed with a random number.

29. The computer-readable medium of claim 26, further comprising instructions to cause the processor to perform the operations of receiving the random number from the plug-in device.

30. The computer-readable medium of claim 26, where generating a key from the host seed comprises generating the key from the host seed and a device seed.

31. The computer-readable medium of claim 26, where the method further comprises authenticating the security device prior to retrieval of the secret.

32. The computer-readable medium of claim 31, where authenticating comprises encrypting a random number to create an encrypted random number, sending the encrypted random number to the plug-in device and receiving a success message from the plug-in device.

33. The computer-readable medium of claim 31, where successfully authenticating the plug-in device is required to perform the step of creating a key from the host seed.

34. The computer-readable medium of claim 26, further comprising instructions to cause the processor to perform the operations of:
detecting that the plug-in device has been disconnected from a security device; and
in response to detecting the disconnection, removing the key from memory or disabling any encrypting or decrypting functions.

35. A computer-readable medium including instructions, which when executed by a processor, causes the processor to perform the operations of:
receiving a request to facilitate secure encryption or decryption operations;
providing a randomly generated number;
receiving a secret created from the randomly generated number and a host seed; and
storing the secret until run-time.

36. The computer-readable medium of claim 35, further comprising instructions to cause the processor to perform the operations of:
authenticating a requestor of the mixed seed; and
providing the mixed seed to the requestor after successfully authenticating the requestor.

37. The computer-readable medium of claim 36, where authenticating the requestor comprises:
encrypting the randomly generated number to create a locally encrypted randomly generated number;
comparing the locally encrypted randomly generated number with an encrypted randomly generated number received from the requester; and
determining if there is a match, and if so, providing the secret to the requester.

38. The computer-readable medium of claim 36, instructions to cause the processor to perform the operations of performing a validation step, including determining whether a sequence of data received from the requestor matches a stored sequence of data.
